(19) United States
(12) Patent Application Publication
(10) Pub. No.: US 2007/0023473 A1
(43) Pub. Date: Feb. 1, 2007

(54) Spring-powered stapler

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/527,339

(22) Filed: Sep. 26, 2006

Related U.S. Application Data
(63) Continuation of application No. 11/182,591, filed on Jul. 14, 2005.

(51) Int. Cl. B25C 5/06

(52) U.S. Cl. 227/132; 227/120

(57) ABSTRACT

A hand operated stapling tool, which uses the energy stored in a spring to install staples by an impact blow, is disclosed. A housing body is preferably cast or molded. A hand lever is pivotally attached to the rear of the body, pressing the hand lever stores energy in a power spring through an actuating lever inside the housing body, and further pressing the hand lever releases the stored energy in an impact blow by a driving blade, which expels a staple down the housing body. A bend on the driving blade engages an actuating lever, and such structure make the stapler more compact. A staple feeding track is formed at the bottom of the housing body, and the stored staples are secured by a rear-hinged panel.

### CROSS-REFERENCES

This application claims the benefits of U.S. patent application Ser. No. 11/182,591, which was filed on Jul. 14, 2005 and entitled “Spring-Powered Stapler”

### BACKGROUND OF THE INVENTION

The present invention generally relates to hand-operated fastener applying devices and specifically to spring powered staplers.

Various spring-powered staplers employ basically the same operating principle that is to use a spring to store energy, which is then released to drive a blade to expel a staple out of the bottom of the spring-powered stapler. The stapler of the invention also uses this operating principle, but makes the structure more compact and more simplified.

U.S. Pat. No. 5,988,478 issued to Marks discloses a stapling machine in which both a power spring and an actuating level links to a plunger through openings in the plunger. In order to accommodate both links, the size of the plunger has to be large, that makes the hand-operated machine less compact.

U.S. Pat. No. 5,765,742 issued to Marks discloses a stapling machine in which a fastener guide track slidable within the fastener chamber. The separate fastener guide track is a complicated structure, hence costly to manufacture.

U.S. Pat. No. 2,326,540 issued to Krantz discloses a staple gun in which a hand lever is pivoted at the back and an actuating lever engages a vertically positioned spring and driving assembly, and because of that, Krantz's staple gun is quite bulky.

U.S Pat. No. 2,671,215 issued to Abrams discloses a staple gun with similar vertically placed spring and driving assembly, but a different actuating means.

U.S. Pat. No. 2,769,174 issued to Libert discloses a staple gun in which an actuating means employs two linked levers and spring and driving member assembly vertically positioned.

U.S. Pat. No. 3,862,712 issued to LaPointe et al. discloses a staple gun with a staple feeding track that slides rearward to expose a staple loading chamber. A releasable latch assembly retains the track in position.

U.S. Pat. No. 4,119,258 issued to Ewig, Jr. discloses a staple gun with a body and hand lever constructed substantially of plastic material. Its hand lever is pivoted in the front and its spring and driving assembly is vertically positioned.

As such, what is desired is a spring-powered stapler that is compact and easy to operate.

### SUMMARY OF THE INVENTION

In the preferred embodiment, a housing body is preferably cast or molded, which houses a driving blade, a power spring with which the driving blade is engaged, a slidable actuating lever that engages the driving blade, and a returning spring. The movement of the driving blade is contained in a vertical chamber. A hand lever is hinged on the rear end of the housing body. A staple feeding track is formed at the bottom of the housing body, with a rear-hinged panel snaps to the sidewalls of the feeding track to prevent staples from falling off the feeding track during operation, and a spring biased pusher to secure the staple(s) to the front of the feeding track.

In order to engage the actuating lever, yet not to take extra space, the driving blade is bent at the top to form a hook. When the hand lever is first pressed, it causes the actuating lever to slide downward and forward, so that the front end of the lifting lever is positioned underneath the driving blade bend. As the hand lever is further pressed, the actuating lever start to rotate, which lifts the driving blade and hence the power spring. This is the stage of storing energy in the power spring. As the driving blade is lifted, it leaves room for a staple being pushed to the front wall of the feeding track, right beneath the driving blade.

In another embodiment, there is a tab on the power spring, and the actuating lever engages only with the power spring through a power spring tab. The driving blade does not engage directly with the actuating lever, and remains a substantially flat sheet.

The driving blade rises in a vertical path in the vertical channel, while the actuating lever rotates in an arc path, as a result, the actuating lever disengage driving blade near the top position as shown. Then the power spring forces the driving blade to move downward instantly, ejecting the staple at the staple exit position in the front of staple feeding track.

When the hand lever is released, the returning spring pushes up the rear end of the actuating lever and hence the hand lever to their upper most resting position.

A rear-hinged retention panel snaps into the sidewalls of the staple feeding track, which prevents the staple(s) from falling off the feeding track. A spring biased, sliding pusher pushes the staple magazine to the front of the feeding track. In the preferred embodiment, a coiled spring is connected between the front of the retention panel and the sliding pusher. When the retention panel swings open, the coiled spring pulls the sliding pusher to the rear end of the feeding track so that staple magazine can be placed in the front portion of the feeding track. In other embodiments, the sliding pusher can be pushed forward by a pushing coiled spring.

This compact front end gripped and front end staple exiting design of the preferred embodiment can provides the advantage of simplicity and a staple applying action similar to that of a hand-pressed desktop stapler.

### BRIEF DESCRIPTION OF THE DRAWINGS

FIG. 1 is a side elevational view of preferred embodiment stapler, shown in a partial sectional view, of the present invention in a resting position.

FIG. 2 is a side elevational view of the stapler of FIG. 1, just prior to ejection of a staple.

FIG. 3 is a perspective view of the actuating lever, the driving blade and their engagement through a bend on the driving blade.

FIG. 4 is a perspective view of the driving blade with a bend and two openings for engaging the actuating lever and power spring, respectively.

FIG. 5 is a perspective view of the actuating lever, the driving blade and their engagement through a tab on the power spring.

FIG. 6 is a bottom plan view of the stapler with the staple retaining panel snaps to the sidewall of the staple guiding track.

FIG. 7 is a section view of the staple feeding track with a coiled spring pusher inside.

FIG. 8 is a section view of the snap means on the sidewall of the staple feeding.

FIG. 9 is a side plan view of a handle of the staple retaining panel accommodated in a notch on the sidewall of the staple feeding track.

### DESCRIPTION OF THE INVENTION

In the following description, numerous details such as specific materials and configurations are set forth in order to provide a more complete understanding of the present invention. However, it is understood by those skilled in the art that the present invention can be practiced without those specific details. In other instances, well-know elements are not described explicitly so as not obscure the present invention.

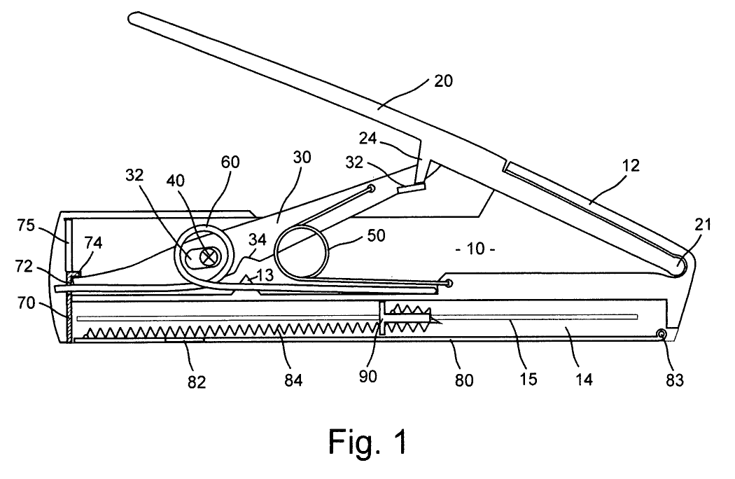

FIG. 1 shows all the essential elements of the present invention. A housing body 10 is shown with one half removed to expose the internal components.

A staple driving blade 70 is contained in a vertical channel 75 and movable therein. In order to engage an actuating lever 30, the driving blade 70 has a bend 74 at its top. The bend 74 is so angled that the actuating lever 30 is able to lift driving blade 70 and to allow disengagement when driving blade 70 is lifted to a top position.

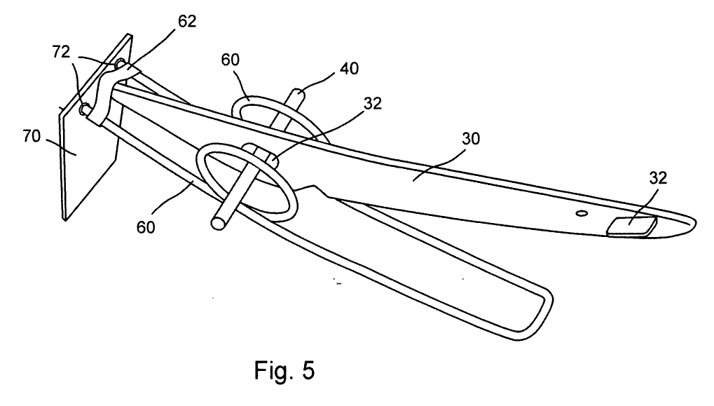

In another embodiment, there is a tab 62 mounted on a power spring 60 as shown in FIG. 5, and the actuating lever 30 engages only with the power spring 60 through tab 62. The driving blade 70 does not engage directly with the actuating lever 30, and remains a substantially flat sheet.

The Power spring 60 links to the driving blade 70 through opening(s) 72 on the driving blade, and provides a downward bias upon driving blade 70. The downward motion by power spring 60 and driving blade 70 is limited by the housing body 10, so that driving blade 70 does not extrude from the bottom of the housing body 10.

The actuating lever 30 is slidably, pivotally mounted on a pin 40, which is then fixed on the housing body 10.

A hand lever 20 is hinged on a rear end of housing body 10. A column extension 21 from the rear end of hand lever 20 inserts into a circular slot formed by walls of housing body 10, serving as a hinge for hand lever 20. A top panel 12 of the housing body 10 limits the travel of the hand lever 20.

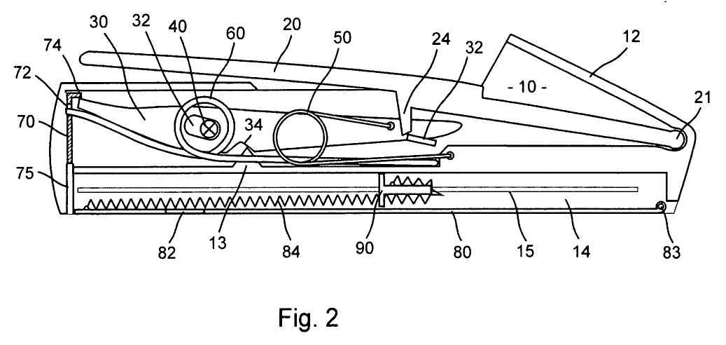

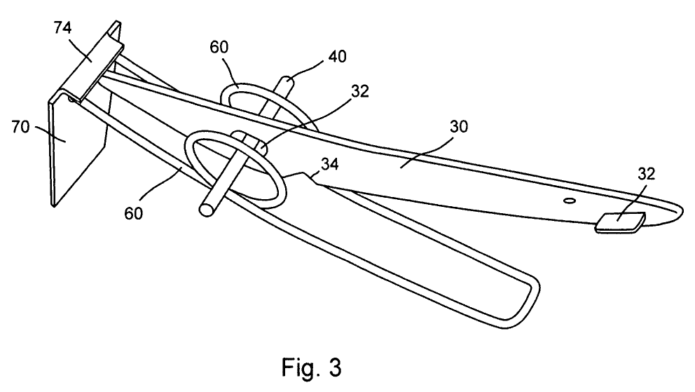

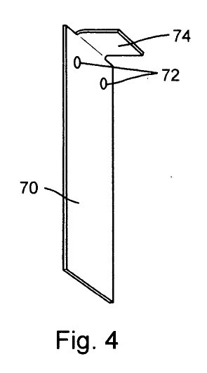

A rib 24 on the hand lever 20 engages a tab 32 on the actuating lever 30. As the hand lever 20 is first pressed, the actuating lever 30 is pushed downward and forward at the same time, and engages the driving blade 70 under the bend 74. Further pressing down the hand lever 20, the actuating lever 30 lifts the driving blade 70 to a position shown in FIG. 2. The lifting of driving blade 70 leaves room for staple magazine being pushed forward by a pusher 90 to the front wall of a feeding track 14, and places a frontal staple in the same plane as the vertical channel 75 and right beneath the lifted driving blade 70.

The driving blade 70 rises in a vertical path along the vertical channel 75, while actuating lever 30 rotates in an arc path, as a result, the actuating lever 30 disengages driving blade 70 near the top position as shown in FIG. 2. Then power spring 60 forces driving blade 70 to move downward instantly, expelling the frontal staple down below the housing body 10.

In another embodiment, the disengagement of the driving blade 70 and the actuating lever 30 is achieved through disengagement of the rib 24 and the tab 32 as shown in FIG. 2. Since downward rotation of the hand lever 20 causes the rib 24 to shift forward; the resulting rotation of the actuating lever 30 causes the tab 32 to shift backward, the rib 24 and the tab 32 is so sized and placed, when the hand lever 20 is pressed down to a certain point, the rib 24 and the tab 32 will disengage as shown in FIG. 2, then hand lever 20 will no long press the actuating lever 30. The pressure of power spring 60 and the pulling of a returning spring 50 cause the actuating lever 30 slide backward and disengage the driving blade70. With the lifting force removed and the actuating lever 30 out of the way, the power spring 60 is then released, which forces the driving blade 70 downward and expels a staple.

Yet in another embodiment, the disengagement of the actuating lever 30 and the driving blade 70 is achieved through a notch 34 on the actuating lever 30 and a protrusive wedge 13 at the internal surface of housing body 10 as shown in FIG. 1. When the rear side of actuating lever 30 being pressed close to the bottom, the slope of said notch 34 meets wedge 13 as shown in FIG. 2, which forces the actuating lever 30 to slide backward at further pressing. In this embodiment, the tab 32 on the actuating lever 30 and rib 24 on the hand lever are optional.

The returning spring 50 exerts an upward and backward bias on actuating lever 30. When the hand lever 20 is released, the returning spring 50 forces the actuating lever 30 and hence the hand lever 20 back up to their respective resting positions as shown in FIG. 1.

The driving blade 70 includes a vertical portion as a driving blade itself, and a bend 74 as a link to the actuating lever 30. The vertical portion of driving blade 70 is a thin sheet metal form that is substantially flat except for small out-of-plane features, which may be incorporated as a design choice. A completely flat portion of the driving blade 70 may also be used. The bend 74 is preferable bended at right angle relating to the flat portion of the driving blade 70, but can be at any angle from 0 degree to 180 degree relating to the flat portion as long as a link to the actuating lever 30 can be established, and disengagement of the two elements is allowed near the top of the range of motion by the driving blade 70. The thickness of the sheet metal used to make the driving blade 70 is less than the thickness of a standard staple, and is strong enough to endure the lifting by the actuating lever 30.

The feeding track 14 is formed at the bottom of the housing body 10. There are guiding slots 15 on each internal sidewall of the feeding track 14. The slidable pusher 90 has tabs 92 on both sides, which fit in guiding slot 15 to retain the pusher 90 inside the feeding track 14 as shown in FIG. 7.

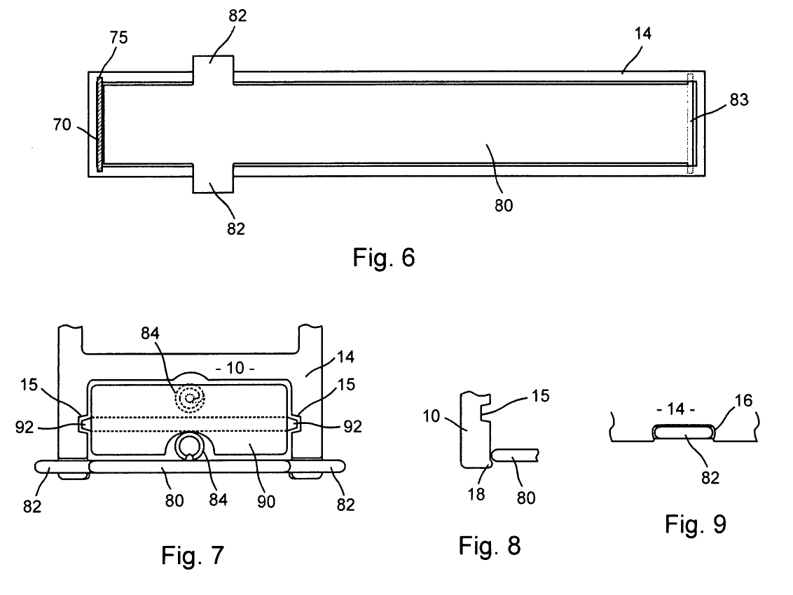

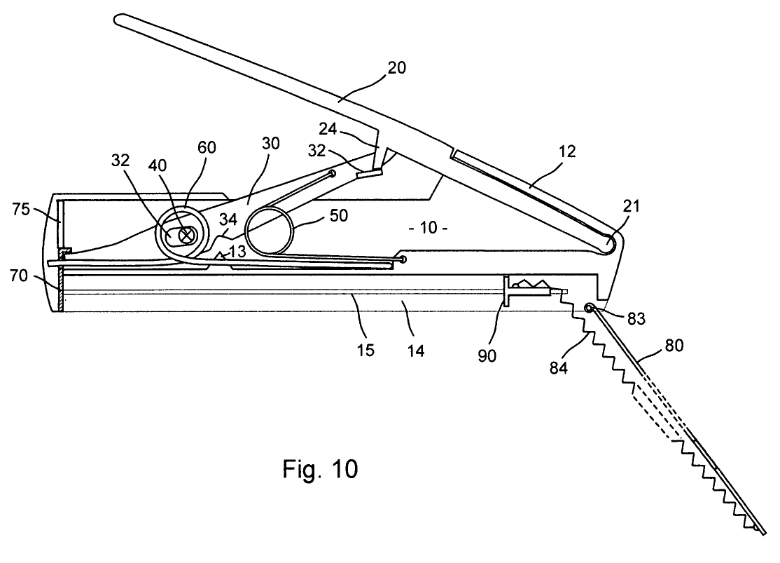

A retention panel 80 snaps to the bottom of the feeding track 14 to keep staples inside the feeding track 14 during normal operation as shown in FIG. 6. FIG. 8 shows that the feeding track 14 has a protrusive profile 18 near the bottom of its sidewalls 10, and the way how the retention panel 80 snaps to the sidewalls. A rear pin 83 formed on the retention panel 80 is hinged on a rear end of the sidewalls of the feeding track 14 and serves as a hinge for the retention panel 80. There is a gap between the front end of the retention panel 80 and the front internal wall of housing body 10, which forms a staple exit slot to allow an expelled staple to exit. Handles 82 on both sides of retention panel 80 fit into notches 16 formed on the bottom sidewalls of the feeding track 14, to serve both as a holding place to pull open retention panel 80, and to stop retention panel 80 from being pushed further into the feeding track 14. The Handles 82 optionally snaps to the notches 16.

The retention panel 80 is preferably a thin sheet metal or plastic form, but can also be constructed out of metal wire, as the surface needed to retain staple magazine is only at the two elongated sides of the feeding track 14.

A coil spring 84 biases the pusher 90 to push staple(s) forward to the front of feeding track 14. One end of the coil spring 84 is attached to the pusher 90, and the other is attached to the retention panel 80. When the retention panel 80 is opened, the coil spring 84 drags pusher 90 to the back of feeding track 14 as shown in FIG. 10, exposing the chamber of the feeding track 14 for placing a staple magazine.

What is claimed is:

1. A staple feeding track comprising:
a housing body having a bottom opening facing the object of being stapled;
a retention panel hinged on a first longitudinal end of the housing body substantially covering the bottom opening and leaving a space for an expelled staple to exit in a second longitudinal end of the housing body; and
at least one protrusive object on the lower end of each internal sidewall of the housing body,
wherein the retention panel snaps on the protrusive objects when covering the bottom opening of the housing body and is held by the protrusive objects therein.

2. The staple feeding track of claim 1, wherein the housing body is made of plastic material.

3. The staple feeding track of claim 1, wherein the retention panel has at least one opening.

4. The staple feeding track of claim 1, wherein the protrusive objects are formed as part of the housing body.

5. The staple feeding track of claim 1 further comprising:
at least one slot formed longitudinally on each internal sidewall of the housing body;
a pusher slidable along the longitudinal slots for pushing one or more staples in the feeding track toward the second longitudinal end of the housing body; and
a spring with a first end connected to the retention panel and a second end connected to the pusher,
wherein when the retention panel swings to a first position covering the opening of the housing body, the spring urges the pusher toward the second longitudinal end of the housing body, and when the retention panel swings to a second position exposing the opening of the housing body, the spring pulls the pusher toward the first longitudinal end of the housing body.

6. The staple feeding track of claim 5, wherein the spring is a coil spring.

7. The staple feeding track of claim 1 further comprising:
at least one handle protruding from each longitudinal edge of the retention panel; and
at least one notch on each longitudinal sidewall of the housing body wherein the handles fit in the notches and serve as a holding place for pulling the retention panel open to expose the bottom opening of the housing body.

8. A staple feeding track comprising:
a housing body having a bottom opening facing the object of being stapled;
a retention panel hinged on a first longitudinal end of the housing body substantially covering the bottom opening and leaving a space for an expelled staple to exit in a second longitudinal end of the housing body;
at least one protrusive object on the lower end of each internal sidewall of the housing body, wherein the retention panel snaps on the protrusive objects when covering the bottom opening of the housing body and is held by the protrusive objects therein;
at least one slot formed longitudinally on each internal sidewall of the housing body;
a pusher slidable along the slots for pushing one or more staples in the feeding track toward the second longitudinal end of the housing body; and
a spring with a first end connected to the retention panel and a second end connected to the pusher, wherein when the retention panel swings to a first position covering the opening of the housing body, the spring urges the pusher toward the second longitudinal end of the housing body, and when the retention panel swings to a second position exposing the opening of the housing body, the spring pulls the pusher toward the first longitudinal end of the housing body.

9. The staple feeding track of claim 8, wherein the housing body is made of plastic material.

10. The staple feeding track of claim 8, wherein the retention panel has at least one opening.

11. The staple feeding track of claim 8, wherein the protrusive objects are formed as part of the housing body.

12. The staple feeding track of claim 8, wherein the spring is a coil spring.

13. The staple feeding track of claim 8 further comprising:
at least one handle protruding from each longitudinal edge of the retention panel; and
at least one notch on each longitudinal sidewall of the housing body wherein the handles fit in the notches and serve as a holding place for pulling the retention panel open to expose the bottom opening of the housing body.

14. A staple feeding track comprising:
a housing body having a bottom opening facing the object of being stapled;
a retention panel hinged on a first longitudinal end of the housing body substantially covering the bottom opening and leaving a space for an expelled staple to exit in a second longitudinal end of the housing body;
at least one protrusive object on the lower end of each internal sidewall of the housing body, wherein the retention panel snaps on the protrusive objects when covering the bottom opening of the housing body and is held by the protrusive objects therein;
at least one handle protruding from each longitudinal edge of the retention panel; and
at least one notch on each longitudinal sidewall of the housing body wherein the handles fit in the notches and serve as a holding place for pulling the retention panel open to expose the bottom opening of the housing body.

15. The staple feeding track of claim 14, wherein the housing body is made of plastic material.

16. The staple feeding track of claim 14, wherein the retention panel has at least one opening.

17. The staple feeding track of claim 14, wherein the protrusive objects are formed as part of the housing body.

18. The staple feeding track of claim 14 further comprising:
at least one slot formed longitudinally on each internal sidewall of the housing body;
a pusher slidable along the longitudinal slots for pushing one or more staples in the feeding track toward the second longitudinal end of the housing body; and
a spring with a first end connected to the retention panel and a second end connected to the pusher,
wherein when the retention panel swings to a first position covering the opening of the housing body, the spring urges the pusher toward the second longitudinal end of the housing body, and when the retention panel swings to a second position exposing the opening of the housing body, the spring pulls the pusher toward the first longitudinal end of the housing body.

19. The staple feeding track of claim 18, wherein the spring is a coil spring.
